(19) United States
(12) Patent Application Publication
(10) Pub. No.: US 2025/0308409 A1
(43) Pub. Date: Oct. 2, 2025

(54) METHOD FOR TRANSLATING INPUT TO SIGN LANGUAGE AND SYSTEM THEREFOR

(71) Applicant: VISUAL S L LTD, Kfar Sava (IL)

(72) Inventors: Tal MEGED, Herzliya (IL); Gal KALKSHTEIN, Kfar Neter (IL); Lital KALKSHTEIN, Kfar Neter (IL); Yaniv EYTANI, Kfar Saba (IL)

(73) Assignee: VISUAL S L LTD, Kfar Sava (IL)

(21) Appl. No.: 18/616,955

(22) Filed: Mar. 26, 2024

(51) Int. Cl. G09B 21/00; G06T 13/40

(52) U.S. Cl. CPC G09B 21/009; G06T 13/40

(57) ABSTRACT

A computerized method for translating input to sign language is provided. The method includes obtaining an input, converting the input to representation in a designated sign language, by processing the input, based at least on contextual data associated with the input. Processing the input can be by generating a gloss sequence comprising one or more glosses and extracting visual generation guidance. Visual data corresponding to the gloss sequence can be obtained. representation based on the gloss sequence, the visual data and the visual generation guidance can be generated. The representation can then be provided.

### TECHNICAL FIELD

The presently disclosed subject matter relates generally to language translation systems and methods, and, more particularly, to translating input to sign language in a designated sign language.

### BACKGROUND

Communication barriers between individuals who use spoken language and those who use sign language have long been recognized as a challenge. While text-based translation systems exist, the need for an efficient and accurate method to bridge the gap between spoken and written languages, and sign language, in an accurate manner, has become increasingly apparent. Existing systems often struggle to capture the nuances and expressiveness inherent in the visual representation of sign language, leading to limitations in conveying the intended meaning accurately.

Furthermore, the advent of digital communication platforms and the widespread use of voice-based and text-based communication have created a growing demand for effective tools that facilitate seamless interaction between individuals who use various modes of languages or communication, or between creators of content in the platforms and individuals who use sign languages. Known methods lack a comprehensive solution that seamlessly integrates text-to-sign language translation, while taking into account the nuances and expressiveness or regional variations and the cultural aspect that is inherent in sign language.

Scientific evidence unequivocally shows that Deaf and Hard of Hearing individuals process language in fundamentally different ways than hearing people, underscoring the indispensable role of sign language. Text-based solutions like captions, while beneficial, fall short in several key areas:

Brain Adaptation: The Deaf brain repurposes areas typically dedicated to auditory processing for enhanced visual and tactile perception. This neural flexibility underscores the complexity and richness of sign language that captions cannot match.

Visual Processing: Deaf individuals exhibit advanced visual-spatial awareness, including heightened attention to peripheral events. This adaptation to a life without sound reveals the depth of communication possible through sign language, beyond the linear constraints of text.

Developmental Benefits: For Deaf children, sign language is critical for cognitive and linguistic development. It activates the brain's language centers in a comprehensive manner that captions or subtitles simply can't replicate, supporting essential early learning and development.

Cognitive Advantage: Research has demonstrated a general visual processing advantage among Deaf individuals, suggesting that engaging with a visual language like sign language fosters cognitive benefits beyond the realm of communication. Captions, limited to text, don't leverage this cognitive processing to the same extent.

Hence, there exists a need to enhance the precision of translating inputs, such as text or voice, into sign language, ensuring a representation that faithfully captures the intended meaning of the input.

### General Description

Every language goes beyond being a mere aggregation of words and sentences. Languages that evolve within specific geographical regions mirror the cultural practices and daily lives of the communities they serve. While cultural influence is evident in the vocabulary of a language, it extends far beyond mere word choices. Often, the essence of culture subtly permeates the language through expressions, intonations, and idiomatic intricacies.

Comprehending the true meaning of a sentence in a specific language goes beyond merely dissecting it into individual words or comprehending the sentence's syntax and semantics. It involves delving into how thoughts, emotions, or intentions are intricately woven into the words, expressions, and the structure of the sentence itself.

The same principle applies to sign languages, with variations arising in sign languages developed in distinct geographical regions. For instance, American Sign Language (ASL) differs significantly from Korean Sign Language.

Sign language is a profoundly expressive form of communication that transcends the boundaries of spoken and written language. Unlike the linear structure inherent to verbal and written forms, dictated by the linear progress with the sequences of words, sign language embodies a multi-dimensional and visual spatial language approach to communication, engaging not just the hands but also facial expressions, body movements, and spatial relationships to convey meaning. This holistic use of physical expression allows for nuanced layers of communication that can convey complex concepts, articulate intricate situations, scenes, emotions, and subtleties in a manner that is often more immediate and impactful than the sequential nature of words in spoken or written form.

The non-linear and spatial nature of sign language means that it does not simply translate word-for-word from spoken languages. Instead, it operates on its unique grammatical structures and syntax. This difference highlights the richness of sign languages, offering a vivid, visual, and kinesthetic communication experience that can express ideas and emotions in ways that auditory languages might struggle to capture succinctly. Sign language's capacity for simultaneous expression—where multiple elements of a message can be conveyed at once—allows for a depth and efficiency in communication that linear languages can sometimes lack.

Moreover, sign languages are fully-fledged languages in their own right, complete with their own rules for phonology, morphology, syntax, and pragmatics, just like spoken languages. This complexity allows signers to discuss any topic, from the mundane to the abstract, showcasing sign language's versatility and expressiveness.

These inherent characteristics of sign language-its expressiveness, multidimensionality, and non-linear and spatial nature-pose significant challenges for technological solutions aimed at translating speech into sign language. The task is not merely about converting spoken or written words into sign language gestures but also about capturing the subtleties of expression, the nuances of facial expressions, and the context conveyed through body movements.

Current technologies, such as speech recognition and machine translation, have made significant strides in interpreting and translating spoken and written languages. However, the leap to accurately and meaningfully translating speech into sign language requires a sophisticated understanding and integration of visual-spatial elements that are core to sign language communication. The technology must not only recognize and translate words but also interpret and convey the emotional tone, intention, and subtle cues that are integral to the message being communicated.

Developing such technology involves overcoming hurdles in artificial intelligence, computer vision, animation and human-computer interaction. It requires systems capable of learning and accurately reproducing the complex grammar, syntax, and lexicon of sign language, along with the ability to interpret and express the non-verbal cues that are crucial for effective communication.

To illustrate the above, the manner in which a question is formulated in English, such as “Are you hungry?” would undergo a transformation when expressed in American Sign Language in an accurate manner, in context. This transformation may usually involve a reduced ASL form by removing some words (such as auxiliary verbs, articles, prepositions and other) and reordering of words to visually convey the message. Also, while in spoken language the speaker may use tone and pitch to denote a question, the transformation to sign language would have to accompany the signs by specific facial expressions (referred to herein and below also as Non-Manual Markers NMM) like raising eyebrows and head movements to denote the question and the topic of the sentence. For example, in ASL, the following would be presented: “YOU HUNGRY?” or even just “HUNGRY?”, with the appropriate raising of the eyebrows.

Another illustrative example pertains to idiomatic intricacies, which encompass expressions or phrases in a language carrying meanings beyond the literal interpretation of individual words. These expressions unique to a language may not be directly translatable, and frequently carry contextual significance. Consider the English verb used to describe flying. In American sign language (ASL) there is a destination that does not exist in English whether it is Fly as in an insect versus it is Fly as in traveling by an airplane. Consider further the sentence “Queen is my favorite rock band” as an example of a Rock band named Queen that is favorable, a literal word-for-word translation into sign language might visually depict a ‘queen’ in a kingdom, a ‘rock’ as a large stone, and a ‘band’ in the sense of a medical strip, illustrating the potential challenges in conveying idiomatic meanings through sign language. Another example pertains to names of persons or entities referred to in the spoken language. The transformation to sign language can include the use of indexing (pointing), where relevant, instead of using the name of a person or the entity.

There is therefore provided, in accordance with certain embodiments of the presently disclosed subject matter, a translation platform that enables the operation of computerized methods for translating input to sign language. The translation platform may include a User Interface (UI) displayed on a display, such as a user display. The user can input text or voice. An Application Programming Interface (API) communicating with the UI may receive the input and may operate, together with a translation system, to translate the input to sign language representation. Optionally, animation data can be rendered, e.g., by providing or displaying a 3D or 2D visual character, such as an avatar, performing the representation.

The integration of the translation platform through an open and accessible UI communicating with the API, such that the translation is provided as a SaaS solution, involves various advantages over traditional methods, requiring dedicated application downloads, providing off-line services only, or walled gardens which cannot be easily extended by third party applications, use cases or vendors.

Also, the translation platform, in accordance with certain embodiments of the presently disclosed subject matter, provides an automatic computerized real time accurate and reliable translation service of content, a platform which is not accessible in known methods. Thus, usage of certain embodiments of the presently disclosed subject matter enables to provide a real time translation service and to provide visual presentation of content, such as presentation of an avatar or 3D animation content on a display which presents the content of a meeting that is held in a room, which is captured and translated, optionally, in real time. Such usage may enable the involvement and participation of Deaf participants in the meeting and extend the usage of sign languages in non real time scenarios like translating web content a priori ensuring compliance and adherence to regulations.

Non limiting examples of using the translation platform described throughout this document can be in combination with Large Language Models (LLM) models, e.g. known LLM models such as Seq2Seq, BERT (and variants), GPT, Bert, LaMDA, T5 etc. Such usage can provide personal assistant systems to users using sign language in the advantageous manner described throughout this document. In such examples, the user communicates with an LLM model, e.g. through a reception unit such as a microphone or text Input Interface such as keyboard, touchscreen, or any interface designed for the user to enter text directly into the system or a camera for receiving visual inputs and convert them, using known methods, to a format which is enabled to be processed by LLM models. The reception unit enables the user to communicate with LLM models to ask questions or receive information based on data available to the LLM model or found within the model itself. The communication can be received from the user using free text or voice input, as currently known in usage of LLM models. The user's input may be processed by the LLM model to generate processed data. The output processed data may then be used by the translation platform, for example, by transmitting it the translation platform, e.g., using an API of the translation platform as described below. The output is processed by the translation platform to generate a representation of the output in the manner described further below. The representation can then be provided to the user using an output interface, e.g., by displaying it on a display available on the user's device or a separate display operatively communicating with the translation platform.

Other examples of the using the translation platform described throughout this document can be by providing data which needs to be communicated to the user, first to the translation platform and then providing visual representation of the data to the user. Such usage can also provide personal assistant systems which communicate data to users using sign language in the advantageous manner described throughout this document. Assuming examples of some active systems that generate events of various kinds, and data indicative of the operation of such systems, or events generated in the systems, should be provided to the user. These active systems can be external to the translation platform but may operatively communicate with the translation platform. In such examples, the data that needs to be communicated to the user can first be communicated to the translation platform, and be received by a reception unit, e.g., such as described above and further below. The reception unit may be configured to receive an input from one or more external systems. The reception unit may comprise one or more processors configured to process the input using language learning models (LLMs) to generate processed data. The personal assistant system may also comprise one or more processors configured to translate the processed data to sign language utilizing the process described throughout this document by the translation platform to generate a visual representation of the data. The personal assistant system can also comprise an output interface for providing the representation in the manner described above and further below.

According to certain embodiments of the presently disclosed subject matter, during the translation, contextual data associated with the input can be used to process the input and provide data and guidance on how to visually translate the input in a more accurate manner. In the example of the sentence “Queen is my favorite rock band”, the computerized method, in accordance with certain embodiments of the presently disclosed subject matter, would have been achieved a more accurate translation into a sign language compared to known methods, as “Queen” would have been translated in a correct manner, while considering the meaning of the sentence and the context of a rock band.

It should be noted that although reference is made to spoken language, this term should not be considered as limiting, and may also include written language. Also, an input referred to herein and below, can include written input, but can also include input captured by audio or video, and is converted to written input using known methods.

According to a first aspect of the presently disclosed subject matter there is provided a computerized method for translating input to sign language, the method comprising:
obtaining an input;
converting the input to representation in a designated sign language, by:
   processing the input, based at least on contextual data associated with the input, to:
      generate a gloss sequence comprising one or more glosses; and
      extract visual generation guidance;
   obtaining visual data corresponding to the gloss sequence; and
   generating representation based on the gloss sequence, the visual data and the visual generation guidance; and
providing the representation.

In addition to the above features, the computerized method according to this aspect of the presently disclosed subject matter can optionally comprise in some examples one or more of features (i) to (xix) below, in any technically possible combination or permutation:
(i) The method further comprising:
   configuring an avatar to perform the representation;
   rendering the avatar.
(ii) Wherein obtaining an input comprises receiving the input through an API platform.
(iii) Wherein translating the input to the sign language is performed in real time.
(iv) Wherein processing the input further comprises:
   extracting contextual data from the input; and
   processing the input based at least on the extracted contextual data.
(v) Wherein converting the input further comprises:
   prior to processing the input, restructuring or reducing the form of the input.
(vi) Wherein processing the input to generate the gloss sequence further comprises:
   generating an initial gloss sequence comprising one or more initial glosses based on the input; and
   modifying the generated initial gloss sequence based on the contextual data, to generate a modified gloss sequence.
(vii) Wherein modifying the generated initial gloss sequence further comprises: replacing at least one of the initial glosses with a different gloss.
(viii) Wherein replacing at least one of the initial glosses further comprises:
   for at least one of the initial glosses, generating a new gloss based on the initial gloss; and
   replacing one of the initial glosses with the new gloss.
(ix) Wherein the new gloss represents finger spelling of a word.
(x) The method further comprising:
   determining, based on the contextual data, that a particular finger spelling gloss surpasses a particular one of the initial glosses; and
   replacing the particular initial gloss with the particular finger spelling gloss.
(xi) Wherein processing the input to generate a gloss sequence comprises applying on the input at least one technique selected from a group comprising: N-grams to gloss, synonyms, finger spelling, homograph disambiguation, Temporal Aspect Modifiers, and number classifications.
(xii) Wherein processing the input to generate a gloss sequence comprises applying a classifiers matching technique.
(xiii) Wherein processing the input to generate a gloss sequence comprises applying an emotional technique.
(xiv) Wherein obtaining the visual data further comprises:
   for at least a first gloss in the gloss sequence, obtaining visual data of an optimal presentation from among a plurality of visual presentations available for the first gloss.
(xv) Wherein the plurality of visual presentations is generated using one or more techniques selected from a group comprising: Mono-Cam computer vision (CV), Multicam CV, Motion Capture (MoCap) and manual generation.
(xvi) Wherein the visual generation guidance pertains to presentation of the gloss sequence.
(xvii) Wherein the visual generation guidance includes at least two layers of guidance, wherein each layer comprises guidance pertaining to a separate aspect of animation of the gloss sequence.
(xviii) Wherein at least one of the layers is associated with implementation priority over another layer.
(xix) Wherein at least one of the layers pertains to one aspect selected from a group comprising: transitions between at least two of the glosses, emotions, animated Indexing, grammatical structure, Contextual Non-Manual Markers (NMM), classifiers, and avatar humanization.

The presently disclosed subject matter further comprises a computerized system for translating input to sign language, comprising a processing circuitry that comprises at least one processor and a computer memory, the processing circuitry being configured to execute a method as described above with reference to the first aspect, and may optionally further comprise one or more of the features (i) to (xix) listed above, mutatis mutandis, in any technically possible combination or permutation.

The presently disclosed subject matter further comprises a non-transitory computer readable storage medium tangibly embodying a program of instructions that, when executed by a computer, cause the computer to perform a method for translating input to sign language as described above with reference the first aspect, and may optionally further comprise one or more of the features (i) to (xix) listed above, mutatis mutandis, in any technically possible combination or permutation.

The presently disclosed subject matter further comprises a personal assistant system, comprising:
a reception unit for receiving an input from a user;
one or more processors configured to:
process the input using language learning models (LLMs) to generate processed data;
translate the processed data to sign language utilizing a method for translating input to sign language as described above with reference the first aspect, and may optionally further comprise one or more of the features (i) to (xix) listed above, mutatis mutandis, in any technically possible combination or permutation to generate the representation; and
an output interface for providing the representation.

The presently disclosed subject matter further comprises a personal assistant system, comprising:
a reception unit configured to receive an input from an external system, the reception unit comprising one or more processors configured to process the input using language learning models (LLMs) to generate processed data; and
one or more processors configured to translate the processed data to sign language utilizing a method for translating input to sign language as described above with reference the first aspect, and may optionally further comprise one or more of the features (i) to (xix) listed above, mutatis mutandis, in any technically possible combination or permutation to generate the representation; and
an output interface for providing the representation.

### BRIEF DESCRIPTION OF THE DRAWINGS

In order to understand the invention and to see how it can be carried out in practice, embodiments will be described, by way of non-limiting examples, with reference to the accompanying drawings, in which:

FIGS. 1a-1c illustrate an example of an optional screenshot of a translation platform 100, in accordance with certain embodiments of the presently disclosed subject matter;

FIG. 2 illustrates a high-level functional block diagram of a translation system 200, in accordance with certain embodiments of the presently disclosed subject matter;

FIG. 3 illustrates a generalized flow-chart of operations performed by the translation system, in accordance with certain embodiments of the presently disclosed subject matter;

FIG. 4 illustrates an optional screenshot 400 of the translation platform 100, in accordance with certain embodiments of the presently disclosed subject matter;

FIG. 5 illustrates an optional screenshot 500 of the translation platform 100, in accordance with certain embodiments of the presently disclosed subject matter; and

FIGS. 6a, 6b and 6c illustrate a non-limiting example of representation, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “obtaining”, “converting”, “processing”, “generating”, “extracting”, “associating”, “providing”, “configuring”, “rendering”, “translating”, “extracting”, “processing”, “representing”, “reducing”, “restructuring”, “modifying”, “replacing”, “generating”, “determining”, or the like, refer to the action(s) and/or process(es) of a computer that manipulate and/or transform data into other data, said data represented as physical, such as electronic, quantities and/or said data representing the physical objects.

The term “computer”, “computer system”, “computer device”, “computerized device” or the like, should be expansively construed to cover any kind of hardware-based electronic device with one or more data processing circuitries. A processing circuitry can comprise, for example, one or more processors operatively connected to computer memory of any suitable sort, loaded with executable instructions for executing operations, as further described below. The one or more processors referred to herein can represent, for example, one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a graphics processing unit (GPU), a network processor, or the like. By way of non-limiting example, computerized systems or devices can include the translation system 200, disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

As used herein, phrases including “for example”, “such as”, “for instance” and variants thereof, describe non-limiting embodiments of the presently disclosed subject matter. Usage of conditional language, such as “may”, “might”, or variants thereof, should be construed as conveying that one or more examples of the subject matter may include, while one or more other examples of the subject matter may not necessarily include, certain methods, procedures, components, and features. Thus, such conditional language is not generally intended to imply that a particular described method, procedure, component, or circuit is necessarily included in all examples of the subject matter. Moreover, the usage of non-conditional language does not necessarily imply that a particular described method, procedure, component, or circuit is necessarily included in all examples of the subject matter. Also, reference in the specification to “one case”, “some cases”, “other cases”, or variants thereof, means that a particular feature, structure, or characteristic described in connection with the embodiment(s), is included in at least one embodiment of the presently disclosed subject matter. Thus, the appearance of the phrase “one case”, “some cases”, “other cases”, or variants thereof, does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

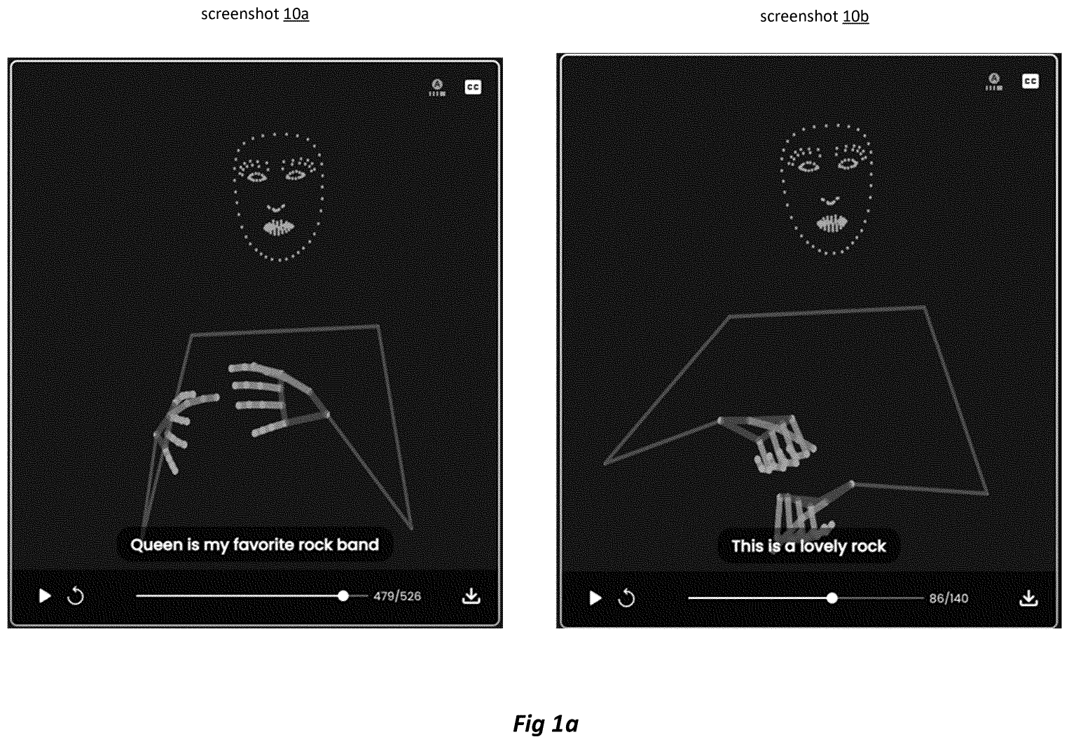

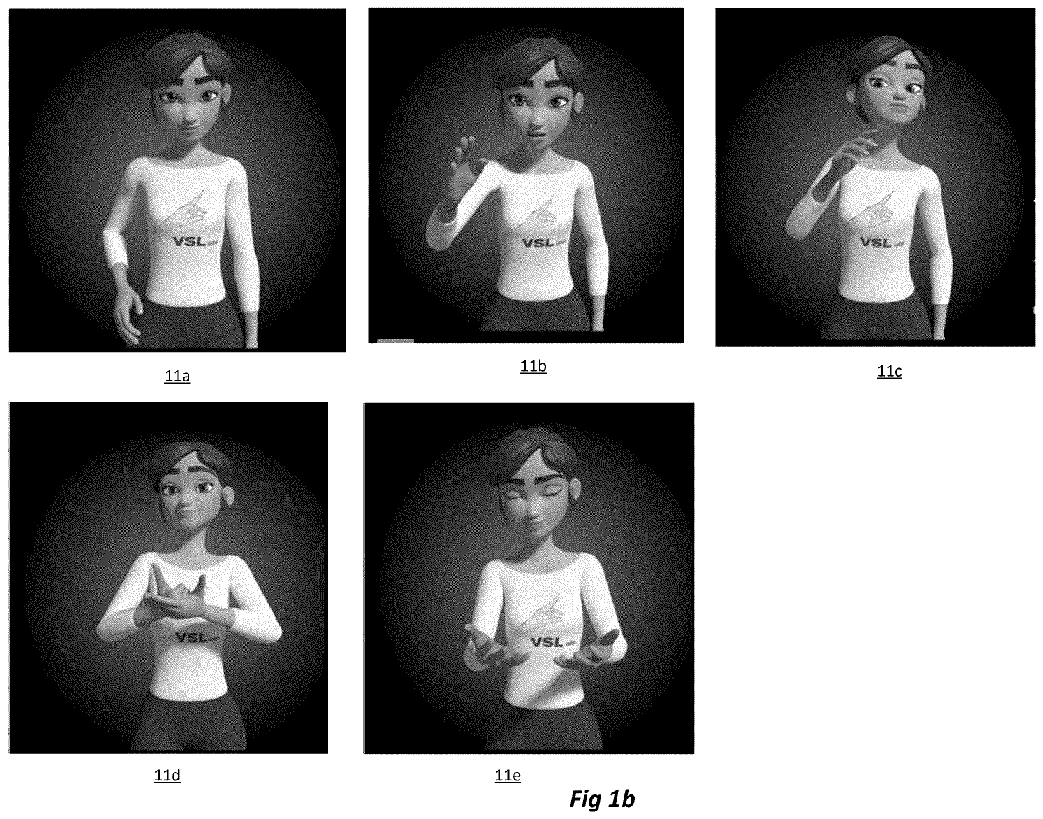

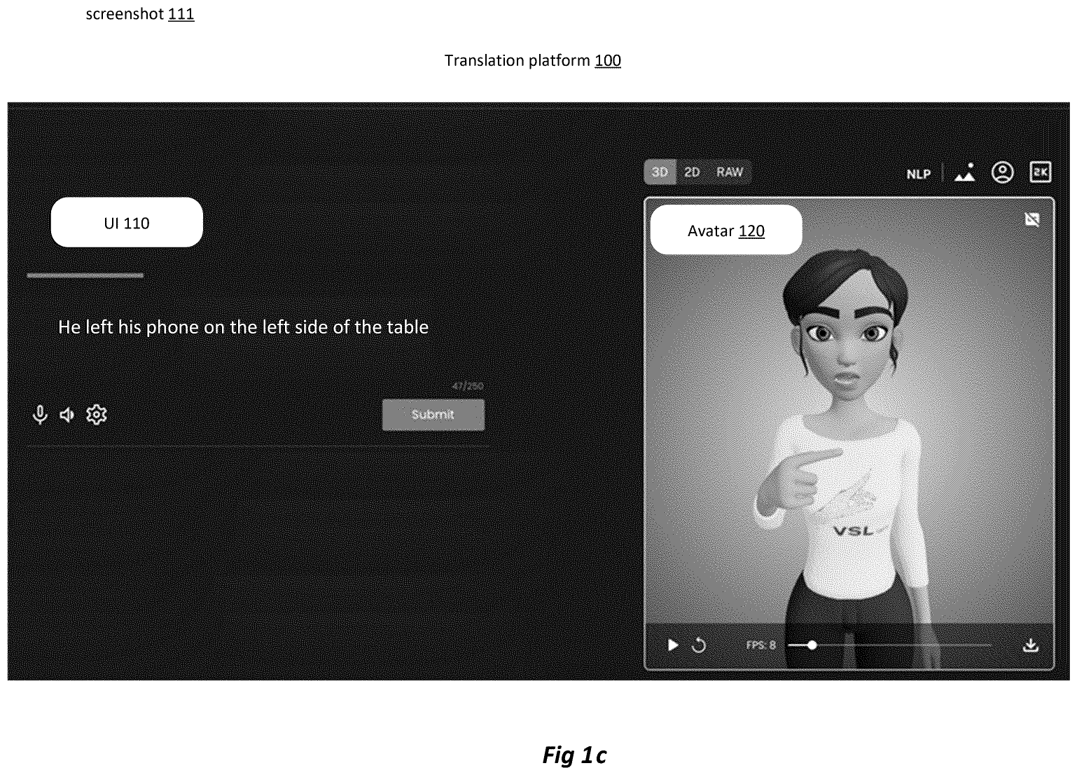

Bearing this in mind, attention is drawn to FIG. 1a illustrating examples of two optional screenshots 10a and 10b that may be displayed on a display to a user, in accordance with certain embodiments of the presently disclosed subject matter. The word ‘rock’ in English can have a meaning of a large stone but can also describe a genre of music. Screenshots 10a and 10b illustrates two representations of the word ‘rock’ in American Sign language (ASL) when having the two different meanings. Screenshot 10a illustrates the representation of ‘rock’ in the example of the sentence “Queen is my favorite rock band”, where ‘rock’ is a music genre, whereas screenshot 10b illustrates the representation of ‘rock’ in the example of a sentence reading: “This is a lovely rock”. Translating each of the sentences in known methods, without relating to context or to guidance on how to present the visual signs, may lead to misrepresentation of the word in the wrong meaning.

Other examples of optional screenshots 11a, 11b, 11c, 11d and 11e, in accordance with certain embodiments of the presently disclosed subject matter, are illustrated in FIG. 1b. Screenshots 11a-11e exemplify specific facial expressions (NMM) and body movement which may accompany the signs themselves, to convey the emotional tone, intention, and subtle cues that are integral to the message being communicated in the sign language. As demonstrated, screenshot 11a depicts an avatar with lowered eyebrows. Screenshot 11b shows the avatar leaning forward. Screenshot 11c presents the avatar with raised eyebrows and a backward lean. Screenshot 11d captures the avatar in a backward lean, initiating a motion sequence that concludes in screenshot 11e, where the avatar moves forward once again. Additionally, screenshot 11e illustrates the avatar closing its eyes, adding a humanizing aspect to the character.

Attention is drawn to FIG. 1c illustrating an example of an optional screenshot 111 of a translation platform 100, as may be displayed to a user, in accordance with certain embodiments of the presently disclosed subject matter. As illustrated, the translation platform 100 is provided. The translation platform 100 is configured to translate input to sign language. In some examples, a user may input content, such as a sentence comprising several words in English, through a User Interface (UI) 110 comprising a dedicated field for inputting content. For example, the reception unit as described above can comprise or operatively communicate with the UI 110. In FIG. 1, the following sentence was inputted to UI 110: “He left his phone on the left side of the table”. An API as a part of a translation system (both not shown) is configured to translate the sentence into sign language and to convert the sentence to representation in a designated sign language, e.g. ASL. The representation can include one or more visual signs corresponding to the sentence, and additional guidance on how to present the visual signs. For example, the personal pronoun “he” or “left side” in the sentence can be converted to corresponding signs of pointing to a certain direction, based on the context, such as to an index that points to a specific person or entity, singular in this case but can be also plural, (previously) located in the 3D space. Translating the sentence will include selection of corresponding visual signs. In addition, the translation system may provide guidance on how to present the visual signs. For example, if the input sentence includes an exclamation mark (‘!’) such as in the example of “don't touch me!”, then the translation system may provide guidance that the visual signs corresponding to the sentence should be presented in a certain manner, for example, in a high tempo, which indicates emotional feelings such as urgency, frustration, or a clear message that is expressed in the original sentence. If the same sentence would have appeared without an exclamation mark (‘!’), such as “don't touch me”, then the visual signs may have been presented differently. Another example is a similar sentence where “I loudly screamed don't touch me”. the semantics of the sentence may change the representation of the same sign.

The visual signs that are to be selected in the translation may already encompass some consideration of the accurate meaning of the sentence. However, providing additional guidance, along with visual signs, as a metadata accompanying the translated visual signs used for presenting the visual signs, is advantageous in order to enable an accurate translation from the spoken language to the sign language, while conveying the tone, pitch and prosody in spoken language. In some examples, the mere translation of visual signs may not be sufficient to convey, in sign language, the faithful meaning of the translated sentence in a reliable manner. Examples for this may be posing a question or using cynicism, where these differentiate the semantic meaning. The guidance is utilized to enhance statically extracted data to solely represent visual signs in sign language and ensures accuracy by incorporating additional, sometimes, overriding, information. Such information can be the use of raising or lowering eyebrows in questions, or may be related to emotional context, Indexing (e.g., pointing to named entities) and other relevant factors required for effective presentation of the visual signs. In some examples, the translation system is further configured to provide a visual character, such as an avatar 120 to perform the representation by displaying a video of the avatar 120 presenting the visual signs based on the guidance, e.g., as described above with reference to FIG. 1b.

It should be noted that the illustrated screenshots in FIGS. 1a, 1b and 1c are presented for illustrative purposes only, and should not be construed as limiting the scope of the claimed subject matter. The depicted user interface is just one example of how the translation service provided by the translation system may be implemented, and various modifications and alternatives can be envisaged by those skilled in the art without departing from the broader aspects of the invention. The specific layout, design, and features shown in the screenshot are not intended to define or limit the claimed invention but are provided to facilitate a better understanding of one possible embodiment. Those skilled in the art will readily appreciate that the teachings of the presently disclosed subject matter are, likewise, applicable to other arrangements of elements and content areas on the display screen.

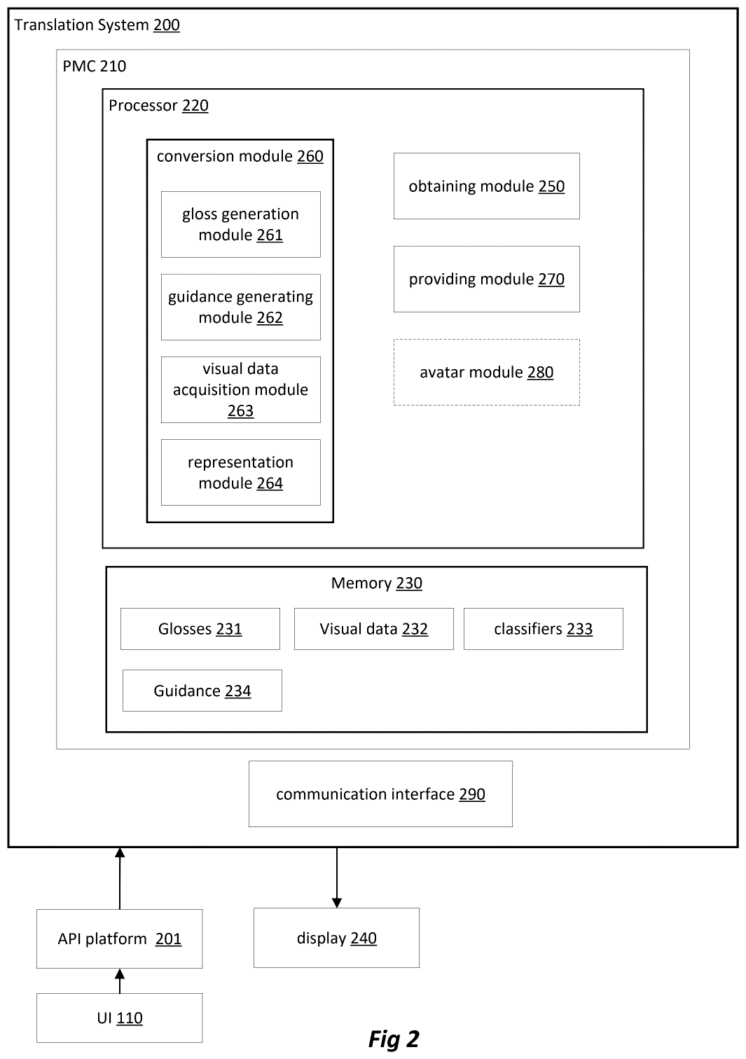

Bearing this in mind, attention is drawn to FIG. 2 illustrating a high-level functional block diagram of a translation system 200, in accordance with certain embodiments of the presently disclosed subject matter. The translation system 200 is configured for translating input to sign language and may comprise several components which operatively communicate with each other. The translation system 200 comprises a processor and memory circuitry (PMC) 210 which comprises a processor 220 and a memory 230.

In some examples, a user may input content to be translated to sign language via the user device, e.g. using the UI 110. Using the API 201 configured to obtain the input, e.g., as input in UI 110. The content is processed by the translation system 200, and visual output in a wide variety of formats, such as video formats including mp4, avi, mov, as well as three-dimensional formats for smarter and more efficient integration into systems, like GLB, GLTF, FBX, BVH, WebGL, etc. can be provided by the API and presented on an output interface described above, such as a display 240. The visual output includes presentation of the input content in sign language. The display 240 can be a display of a user device operated by a user.

Alternatively, the API platform 201 can be incorporated in a standalone computerized device, such as a recording device in a certain room, configured to capture content such as voice. The voice can be processed by the translation system 200 while the visual output can be presented on a display 240 of another device, such as a screen in a meeting room. Those skilled in the art, would realize various implementation of API platform 201 and the translation system 200, in accordance with certain embodiments of the presently disclosed subject matter, for example, by incorporation the platform 201 and the system 200 in websites, online meeting and courses, streaming services, public announcements, mobile application etc.

The processor 220 is configured to execute several functional modules in accordance with computer-readable instructions implemented on a non-transitory computer-readable storage medium such as memory 230. Such functional modules are referred to hereinafter as comprised in the processor 220. The processor 220 can comprise an obtaining module 250, conversion module 260, providing module 270, and avatar module 280. The conversion module 260 can comprise gloss generation module 261, guidance generating module 262, visual data acquisition module 263, and representation module 264.

Memory 230 can store glosses 231 comprising a plurality of glosses corresponding to words or phrases in a spoken or written language, such as ASL, classifiers 233 comprising a plurality of visuals of classifiers applied to various scenes, including descriptive meta-data, as described below, and visual signs 232 comprising a plurality of visual signs corresponding to glosses or classifiers, either such saved in glosses 231 and classifiers 233, or different ones.

The translation system 200 may also comprise a communication interface 290 enabling the translation system 200 to operatively communicate with external devices such the API platform 201, a user device (not shown), the display 240, or the like. Alternatively, the API 201 can be a part of the translation system 200.

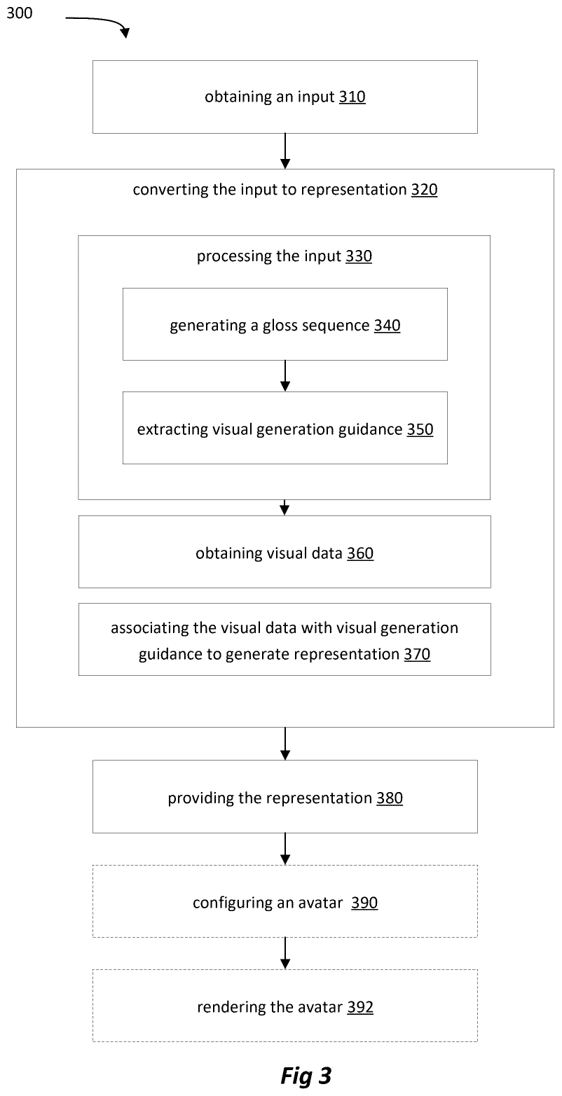

In some cases, the translation system 200 is configured for translating input to sign language. In some examples, processor 220, e.g., using obtaining module 250, is configured to obtain an input. With reference to the illustration in FIG. 1, the input can be text input inserted by a user in API 201 in translation platform 100. Obtaining module 250 is configured to receive the input and transmit it to conversion module 260 configured to convert the input to representation in a designated sign language. For example, the input can be a sentence in spoken English, while the designated sign language can be the ASL. The conversion module 260 is configured to convert the English sentence to representation in ASL. Further details on the conversion process, as executed by components included in conversion module 260, as well as on representation in a designated sign language, are provided below with reference to FIG. 3.

The providing module 270 is configured to provide representation in the designated sign language. For example, the providing module 270 can provide such representation to the avatar module 280 that is capable of configuring a visual character, such as an avatar, to perform the representation, and to render an avatar. Alternatively, or additionally, the providing module 270 is configured to provide the representation by transmitting it, e.g. using the communication interface 290, to an external device (not shown), for example if avatar module 280 is not part of the translation system 200 and configuration of an avatar is performed outside the translation system 200. Additional examples of usages of the translation system 200 are described above and refer for example to incorporating the output of the translation system 200 into various media, from news broadcasts and television programs to more immersive applications.,

FIG. 2 illustrates general schematics of the translation system 200 in accordance with certain non-limiting examples of the presently disclosed subject matter. Elements in FIG. 2 can be made up of any combination of software and hardware and/or firmware that performs the functions as defined and explained herein. Elements in FIG. 2 may be centralized in one location or dispersed over more than one location. For example, each one of elements 250, 260, 270, and 280 can be located at a different geographical location, remote from the other elements. Furthermore, in some examples of the presently disclosed subject matter, the translation system 200 may comprise fewer, more, and/or different elements than those shown in FIG. 2. For example, elements 220 and 260 show several separate elements, each dedicated for executing certain functions of the system, however it would be clear to any person skilled in the art that the functionalities of the system can be otherwise divided. For instance, in an alternative system-design, different functions assigned to obtaining module 250 can be otherwise implemented by conversion module 260. Likewise, various elements described as distributed over different computers can be otherwise consolidated into a single computer device.

Those skilled in the art will also readily appreciate that the data repositories such as memory 230 can be consolidated or divided in other manner; databases can be shared with other systems or be provided by other systems, including third party equipment.

Reference is now made to FIG. 3, illustrating a general flowchart of operations executed by the translation system 200, in accordance with certain embodiments of the presently disclosed subject matter. In some examples, the operations can be performed by entities executed by the translation system 200 illustrated with reference to FIG. 2.

An API such as the API 201 may obtain input content for translation to sign language. In some cases, the computerized method for translating input to sign language is initiated by the obtaining module 250 obtaining an input, e.g. from the API 201 (block 310). The input can be text input such as a sentence in the spoken English language. However, API 201 can also accept input in other formats, such as voice and video, and may convert any non-textual inputs, such as voice and video, into text, using known methods such as speech recognition and image processing, and may also elicit contextual data using known methods such as speaker identification and object segmentation and so on and so forth. The text input, as received or converted to such, can include one or more words to be translated, or sentences comprising a plurality of words. For illustration, the input can be “Queen is my favorite rock band”, “He left his phone on the left side of the table” or “Are you hungry?”.

The input can then be converted to representation in a designated sign language, e.g., by conversion module 260 (block 320). In order to process the input in an accurate manner which maintains the true semantic meaning of the word or sentence, the input can be processed. Processing the input can be based at least on the contextual data associated with the input (block 330). In the example of “Queen is my favorite rock band”, a literal word-for-word translation (Modulo, in the general case grammatical word reordering, deletions and replacement in the sentence) into sign language might visually depict a ‘queen’ in a kingdom, a ‘rock’ as a large stone, and a ‘band’ in the sense of a medical strip. Hence, it is desired to process the input and to extract contextual data associated with the input, so the word ‘Queen’ in the above example, is translated in the context of a rock band, and in addition to provide guidance on how to present the corresponding visual signs in the sign language in a more accurate manner. In the above example, processing the input based on the context can provide guidance of expressing “favorite” as a positive emotion, thereby, when presenting the visual signs corresponding to the words in the sentence, by adding the relevant non manual markers (“MNN”) or some combination of these (e.g., a smile) may result in a positive manner of presentation. In the above example of “don't touch me!”, processing the input based on the context will provide guidance that conveys the negative emotional feelings expressed in the sentence. It should be noted that emotions and NMMs may be used interchangeably, as emotions can be expressed through non-manual markers (NMMs), such as facial expressions and body language. In the context of a digitally generated avatar, these emotions might be represented by specific NMMs or a combination thereof to accurately convey the intended message.

In some examples, the contextual data can be received separately from the input, e.g., can be also inputted via the API platform 201, e.g. manually by the user. For example, if the input is one word such as “cold”, then a context can be added separately, but along with the input: “Are you cold?”. The word “cold” would be translated into sign language differently than translating merely the word “cold” when not accompanied by context (e.g. by changing the state of the eyebrows). In many examples, the contextual data can be extracted from the input itself, such as in the example of “Queen is my favorite rock band”, where the expression of “rock band” is identified, and “Queen” is identified as a rock band accordingly. Extracting the contextual data from the input can be done using known methods.

In some examples, the input is pre-processed and restructured. Restructuring can include breaking the input into different sentences or reducing the form of the English sentence to a more linear structure. For example, an original complex sentence that reads: “engaging in a comprehensive study over several decades, a scientist has meticulously analyzed the intricate patterns of butterfly migration, with an anticipation that her forthcoming publication is poised to offer a paradigm shift in the scholarly understanding of animal migratory behaviors”, a reduced form of an output sentence can read: “after decades of study, a scientist's work on butterfly migration may change how we view animal migration.”

Another example of restructuring the input can include adapting the input to be culturally and contextually appropriate. For example, when dealing with specialized medical terminology from a healthcare provider, the content can be pre-processed into language that's more accessible to a patient. This is particularly pertinent in translating to sign languages, where it's beneficial to break down information into shorter, clearer segments. Take, for instance, an English input like, ‘Your diagnosis is bilateral sensorineural hearing loss, which may require the use of hearing aids or cochlear implants depending on its severity.’ In ASL, this intricate medical diagnosis would be made more accessible by deconstructing it into components easier for the patient to understand, focusing on clear communication from the patient's perspective. Instead of directly translating complex medical terms such as ‘bilateral sensorineural hearing loss,’ the translation would focus on describing the condition in terms understandable to those outside the medical field. The explanation could start by addressing the condition related to the individual's hearing capabilities, using terms like ‘HEARING CONDITION’ or ‘HEARING DIFFERENCE’, avoiding implications of a ‘problem’ which may carry negative connotations.

Rather than mentioning ‘bilateral sensorineural hearing loss’ explicitly, the approach might involve describing the condition as one that affects hearing in both ears due to issues with how the inner ear sends sound to the brain. Instead of initially naming hearing aids or cochlear implants, the explanation would introduce these as tools or devices designed to support clearer hearing or enhance communication, explaining their purpose through signs that visually represent how they aid in hearing. The phrase ‘depending on its severity’ would be translated to emphasize the variability of the hearing condition and the customized support needed, perhaps using signs to indicate varying levels of hearing support, reflecting the individual's specific situation.

Those versed in the art would realize that additional methods can be used to pre-process the input, such as Tokenization and Lemmatization, Normalization, Semantic Analysis, Employing advanced techniques like Word Sense Disambiguation and Contextual Embeddings (Utilizing models like BERT or GPT) to capture the context within which words appear, enabling a deeper understanding of word meanings based on their usage in specific sentences, Rule-Based Systems and Custom Databases including developing databases of common phrases and their ASL translations, including cultural nuances and context-specific interpretations, which can be used to guide the translation process.

Referring back to blocks 320 and 330, processing the input to convert the input to representation in a designated sign language can include generating a gloss sequence comprising one or more glosses (block 340). If the input was pre-processed, in the manner described above, then a gloss sequence can be generated from the pre-processed input.

A ‘gloss’ can be considered as an intermediate step that uses a specialized form of written text to capture the essence of sign language. This step enhances a more accurate translation of the linguistic elements, such as words, phrases, and grammatical structures, from spoken language into sign language. A gloss sequence might consist of a single gloss or multiple glosses, depending on the complexity of the input. Often, each gloss corresponds to a specific word or to a sequence of words from the original or pre-processed input. In some cases, a single gloss might represent a whole phrase or several words together. Glosses 231 stored in memory 230 comprise a plurality of glosses corresponding to words in a spoken language. In order to obtain the suitable gloss sequence for a given input, gloss generation module 261 can retrieve corresponding glosses that match sequences of words in the input. Alternatively, gloss generation module 261 can retrieve corresponding glosses from publicly accessible gloss repositories or databases that store glosses for sign languages.

As discussed above, in some cases, the input can be processed to extract contextual data associated with the input. Alternatively, contextual data can be obtained in a different manner, such as obtaining contextual data input by a user. Processing the input to extract the contextual data can be performed by known large language model (LLM) (such as GPT or T5 models) or other sequence to sequence known methods for machine translation for textual input, or other relevant known methods for input of the type of voice, video etc.

The input, together with the extracted contextual data, can be processed to generate at least two outputs: a gloss sequence and corresponding visual signs, and guidance on how to present the visual signs, in an accurate and faithful manner to the original meaning of the sentence. Processing the input together with the extracted contextual data for generating a gloss sequence can be executed by applying one or more techniques.

First, a natural language processing (NLP) pipeline either rule base or statistical can be leveraged, for processing the input for creating an initial gloss sequence. Neural generative architectures such as transformers (for example, with such model variants as T5 or GPT), present a robust method for converting English inputs into American Sign Language (ASL) glosses. Such models are designed to process and generate language through extensive training on large datasets, allowing them to grasp complex linguistic elements like context, grammar, and semantics effectively.

Secondly, (semantic) search methods for matching and fine-tuning the sequence glosses with ones found in a database can be leveraged. Each gloss in the database may contain additional meta-data in order to facilitate a better matching process. Subsequence search (match) techniques can be any of the following: N-grams to gloss, synonyms, finger spelling, homograph disambiguation, classifiers matching, DM pose, Temporal Aspect Modifiers, and emotional and number classifications. Below are explanations of each technique:
Identifying consecutive expressions composed of a consecutive sequence of glosses (aka N-grams for Glosses), so that the visual marking of the compound expression differs from the separate markings of the sequence of glosses comprising it. In the example of “He left his phone on the left side of the table”, the pair of words “left side” can be identified as an expression and can be replaced with one gloss corresponding to the expression. Other examples include the expressions “two of us” or “next week”. Thus, “next week” may be presented by a single sign by compacting it into one sign, similar to week with some extension, which makes the end result more fluent visually.
Identifying synonyms in situations where visual information about a specific gloss is lacking. This step aims to enrich the vocabulary as much as possible and thus expand translation capabilities. For example, “Please keep your volume down” can be treated as “Please keep your sound down” (Volume->Sound). In English, certain words or phrases might not have a direct one-to-one correspondence in ASL, either because ASL uses different mechanisms to convey meaning or because a specific sign does not exist for a given term. Additionally, ASL, like all languages, evolves, and some terms may become outdated or less commonly used. To address this, the method may include identifying synonyms or near-synonyms in English that can convey the same or very similar meanings but have established signs in ASL. This process may involve understanding the semantic meaning of the phrase in its context. In the example, “Please keep your volume down” is a request for someone to reduce the noise they are making. Identifying other words or phrases that convey the same request. “Volume” relates to the loudness of sound, so a synonym could be “sound,” leading to “Please keep your sound down.” Applying this technique is advantageous as ASL relies heavily on visual and spatial elements to convey meaning. Some English terms might not translate directly into visual concepts, so finding a synonym that has a clear visual representation in ASL is important. Also, the synonym must not only be visually representable in ASL but also appropriate for the context in which the original English phrase is used. In addition, this approach can help expand the vocabulary available for translation, making it possible to convey a wider range of concepts and ideas in ASL.
Contextual Disambiguation of Homographs and Poses. This may be done by identifying the correct meaning or sense for an English word or a gloss (also called Homograph and pose Disambiguation) in situations where a word or gloss can have different meanings, thus requiring different visual markings. For example, a different English sense and also a different gloss for the word ‘cross’ should be used in each of the two sentences: “Cross the street” and “Cross my heart”. In the case of pose disambiguation, cases where a term or gloss may carry different interpretations in sign language compared to spoken language such as English where the English word is not obliged to have the same meaning or have multiple meanings should be identified. The disambiguation of a meaning may be accomplished through an advanced semantic analysis of the sentence.

Some examples of ASL signs that can be disambiguated for English words like “fly” or “wash” based on context and non-manual markers: Fly (insect) vs. Fly (travel in an airplane). For “fly” (insect), a sign with a focus on the hand's position near the face, mimicking the motion of a flying insect may be used, whereas for “fly” (travel in an airplane), a sign with a focus on the motion of the hand moving forward in a plane-like manner (combined with facial expressions conveying the idea of travel) may be used. Another example is Wash (clothes) vs. Wash (hands). For “wash” (clothes), a sign with both hands simulating the motion of scrubbing clothes against a washboard may be used, whereas for “wash” (hands), a sign with one hand making a circular motion on the other hand's palm, emphasizing the act of washing one's hands, may be used.

In these situations, disambiguation of meaning may be achieved through advanced semantic analysis of the sentence by using such methods as LLMs (large language model) or word embeddings with Context (such as BERT or newer variants like DeBerta). Thus, building a classification mechanism may be achieved by using generative AI or classic ML methods on a curated dataset for this challenge.

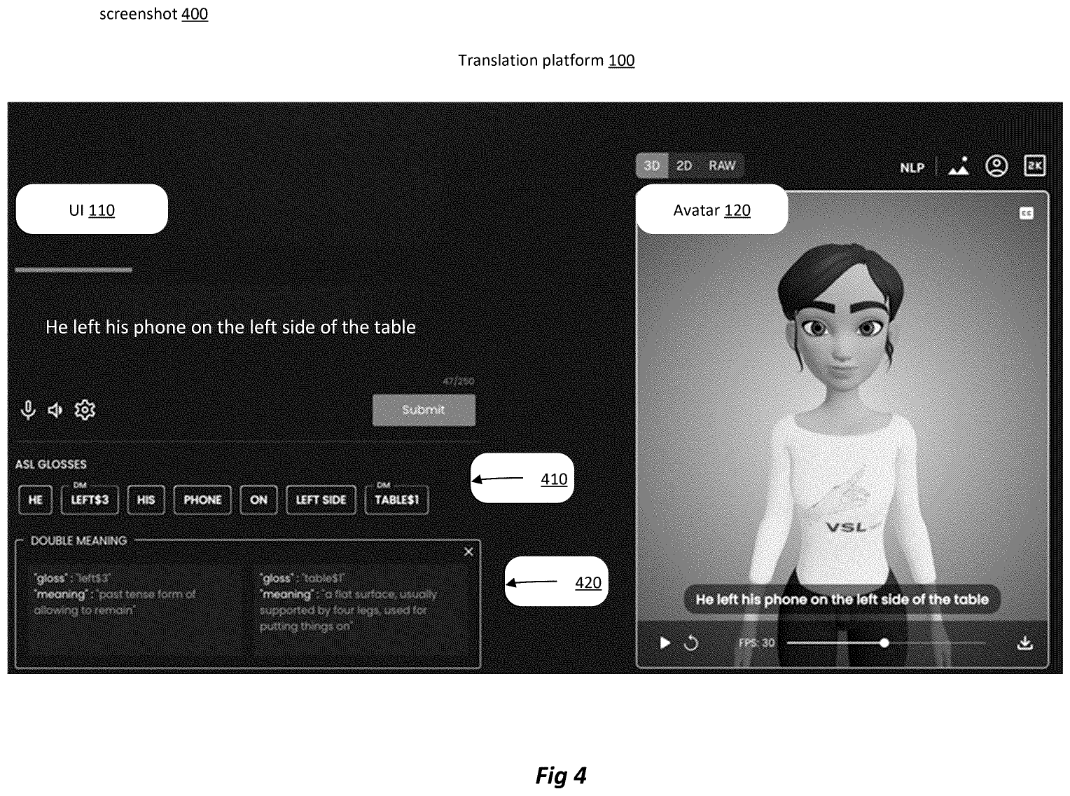

To illustrate the above, reference is made to FIG. 4. FIG. 4 illustrates an optional screenshot 400 of the translation platform 100, in accordance with certain embodiments of the presently disclosed subject matter. The figure illustrates the exemplary input in spoken English language of “He left his phone on the left side of the table”. As described above, a pre-processing stage would result in the sentence: “He left his phone on left side table” (not shown in FIG. 4). Contextual data associated can be extracted from the input. For example, the following contextual data can be extracted:
The first ‘left’ should be interpreted in the meaning of “past tense form of allowing to remain”;
The second ‘left’ should be interpreted in the meaning of directions or sides;
The word ‘table’ should be interpreted in the meaning of furniture or a “flat surface, usually supported by four legs, used for putting things on”, e.g., as opposed to a table in a computer software, such as ‘a chart’.

Processing the (pre-processed) input, based at least on the contextual data that was extracted from the input, results in the gloss sequence referenced to by element 410 including the following sequence of glosses, in the following order: “HE”, “LEFT$3”, “HIS”, “PHONE”, “ON” “LEFT SIDE” “TABLE$1”. The glosses appear in a particular sequence, in a manner suitable for later converting them to corresponding visual signs. ‘DOUBLE MEANING’ field referenced by element 420 illustrates a double meaning of some of the glosses. As illustrated, gloss “LEFT$3” has a double meaning. The meaning of the word ‘left’ in the input should be interpreted as “past tense form of allowing to remain”. As such, the suffix ‘$3′was added to the gloss “LEFT” resulting in “LEFT$3” illustrated in element 410 and is indicative of the accurate meaning of the word. The second ‘left’ in the sentence referred to a direction was attached to the subsequent word ‘side’ and was treated as one phrase, and hence is represented by one gloss “LEFT_SIDE” (as described by the above N-grams methods). Also, the suffix ‘$1’ of the gloss “TABLE$1” is indicative of the accurate meaning of a table as a piece of furniture. In some examples, the content of elements 410 and 420 are not displayed to the user.
Classifiers Matching. In ASL, classifiers are unique handshapes that represent objects, people, places, concepts, and actions. They may play a critical role in conveying additional details such as movement, size, location, shape, and the relationship or interaction between objects within a narrative. Semantic identification of the potential use classifiers and the way these will be applied in the translated sentence, is done by examining the input sentence and further involves utilizing a dedicated classifiers database, such as Classifiers 233. This database may contain one or more pre-defined visual representations of classifiers applied to a given scene or situation and includes specific hand-shapes, textual description and additional meta-data. A machine learning model based on semantic similarity that uses contextual embeddings for matching the textual data and the meta-data is used for matching and identifying which sequence of glosses could be replaced with the applied classifier.

Classifiers in ASL are used dynamically to depict situations involving the objects or entities they represent, rather than being just static representations. For instance, a classifier hand-shape can be used to show how an object moves in space, its orientation, or how multiple objects relate to each other. This dynamic aspect of classifiers allows signers to create vivid, visually descriptive narratives that can express complex spatial and interactive concepts efficiently.

The Classifiers Matching technique thus includes the identification of sequences of glosses in the input that can be effectively represented or replaced by existing classifiers retrieved from the database. This process facilitates that the translation will not only capture the literal meaning of the English input but will also leverage ASL's visual-spatial nature to convey the narrative or descriptive content more expressively and accurately through appropriate classifiers. The classifiers stored in classifiers 233 can be obtained by generating a dedicated database of classifiers where an operator can upload, update and delete a digital version of the classifier (e.g., using video or MoCap recording). Along with each classifier, additional meta-data can be associated such as the semantic description of the classifier and the hand-shape (CL). For example, an animal climbing on a tree with hand shape CL-V (bent). Thus, a cat or a dog climbing on a tree could semantically be replaced with this classifier. Semantic matching may be performed using known methods with combination of linguistic knowledge such as match the classifier hand-shape.

For example, to describe a car moving through a city, an ASL signer might use a specific classifier handshape for “vehicle” and move it through the air to represent the car's path. Additional classifiers could represent buildings or other cars to create a rich, visual description of the scene.

Another example of glosses with and without classifiers is of a person walking. The signs used without a classifier are: PERSON, WALK. The presentation of these signs is that a person is walking, but no information is provided about the manner of the walking or the path taken. The signs used with classifiers are a classifier for a ‘person’ (such as the upright ‘1’ handshape) to show the person walking, the direction they are walking towards, whether they are walking slowly or quickly, and if they are walking straight or meandering. The presentation of this sign enriches the description, allowing the signer to depict the person's walking speed, direction, and path, making the scenario much clearer and more dynamic.

Yet, another example of glosses with and without classifiers is describing a ball rolling. The signs used without a classifier are: BALL, ROLL. The presentation of these signs indicates that a ball is rolling, but without details on the direction, speed, or manner of the roll. The signs used with classifiers are a classifier of a BALL (the topic established, e.g., what the classifier is going to represent). Then a classifier handshape for round objects (such as the ‘CL-3’ or ‘CL-S’ handshape) to show the ball rolling away, towards, or around an object. The presentation of the classifier adds depth to the description, showing exactly how the ball rolls-its direction, the surface it rolls on (implied by the movement's nature), and how fast it is moving.

Yet, another example of glosses with and without classifiers is describing a book on a table. The signs used without a classifier are: BOOK, TABLE, ON. The presentation of these signs conveys that a book is on a table, but there is no information about the book's orientation or its location relative to other items on the table. The signs used with classifiers use the flat handshape classifier to represent the book, and another classifier to represent the table, thus the signer can show the book's exact position on the table (e.g., at the edge, in the center), its orientation (e.g., open, closed, upside-down), and relation to other objects (whether it is next to something else on the table). The presentation of the classifier provides a detailed visual representation of the scene, including the book's position and status on the table, which adds clarity and context to the description. SBS
Temporal Aspect Modifiers technique includes identifying timing and duration of actions. ASL uses specific movements to indicate the timing and duration of actions, whether they are repeated actions or continuous states. For example, to indicate an action that is done repeatedly, the signer might modify the sign “WRITE” with a repeated movement, suggesting “writing repeatedly” or “writes often.” The temporal aspect of signing may affect the actual sign both in speed, prosody, and non-manual markers. In some examples, several versions of one gloss may be required, essentially creating new glosses. For example, “study” vs. “study hard/cramming” vs. “study all day/night” are all going to look different. Once these glosses are created separately, it is required to recognize which one is needed, in a given context, by using semantic annotation on the gloss.
Transitional verbs in sign language may assist in depicting the progression or transition of actions from one state to another. Just as temporal aspect modifiers are used to indicate timing and duration, transitional verbs are used to show how actions evolve or change over time. This technique involves specific sign modifications that reflect the nature of the action's progression, whether it's starting, continuing, changing, or stopping.

For instance, to signify an action that is beginning, a signer might modify the sign for “EAT” with an initial movement, suggesting “start to eat” or “begin eating.” This adaptation helps convey not just the action itself but also its commencement phase. Similarly, to show an action that is in progress or continuing, the sign might be modified to emphasize the ongoing nature of the action, such as elongating the movement associated with “RUN” to indicate “running continuously” or “keep running.”

The transition of actions in sign language is nuanced and can significantly alter the meaning of the sign through variations in movement, speed, and the inclusion of non-manual markers such as facial expressions and body posture. For example, the transition from starting an action to its continuation might require different glosses to accurately represent the action's progression. “Begin to speak” vs. “speaking continuously” vs. “stop speaking” would each have unique representations in sign language to differentiate between the initiation, continuation, and cessation of the action. When creating glosses for transitional verbs, it's advantageous to develop separate glosses for each phase of the action's progression. Recognizing the appropriate gloss to use in a specific context requires detailed semantic analysis and annotation. This ensures that the intended meaning of the action's transition is clearly understood, whether it's the onset, duration, or conclusion of the action.
Directional Verbs in ASL technique involve identifying the directionality and spatial relationships conveyed by verbs. ASL utilizes specific hand movements and orientations to indicate the directionality associated with the action of the verb, reflecting the relationship between the subject and the object. For instance, to convey the action of giving from the signer to another person, the signer would use the sign “GIVE” with a movement from themselves towards the direction of the person receiving. This directional aspect of signing can influence the meaning of the verb, altering its orientation and movement to reflect different spatial relationships.

In some cases, multiple versions of a directional verb might be needed, leading to the creation of distinct glosses to represent these variations accurately. For example, “give to me” vs. “give to you” vs. “give to them” would each have a unique representation in ASL, differing by the direction of the hand movement. After establishing these glosses, the appropriate version for a specific context may be determined through semantic analysis and annotation of the gloss. This approach not only ensures the accurate conveyance of spatial relationships inherent in the verb's action but also enhances the clarity and precision of the communication. By effectively using directional verbs, signers can articulate complex interactions and relationships within the spatial context of their discourse, making ASL a richly expressive language.
Visual spelling (Finger Spelling) is used in situations where words without representation as a gloss in sign language are identified. In the example of “Queen is my favorite band”, the word ‘Queen’ will be represented by a gloss indicating the finger spelling of ‘Queen’ as a name. This technique is usually used for named entities such as names, places, brands, and specific terms that do not have a dedicated sign, technical terms, slang, abbreviations, or when clarity is required. Some of the names may have a dedicated sign, e.g., like for Amazon.
Emotions classification allows for the detection of the speaker's emotional state, which can then be mirrored by the 3D avatar. For instance, a sentence said with excitement or anger in English has different non-verbal cues in ASL. Emotion classification ensures that the avatar's facial expressions and body language match the tone of the message. For example, translating the sentence “The wedding was exciting but then it rained” into sign language with emotion classification involves several steps to capture both the content and the emotional nuances of the statement. Following is a detailed breakdown of how this could be accomplished, especially when using a sign language avatar:

### 1. Identifying the Emotional Content

Excitement: The first part of the sentence conveys a positive emotion, excitement, which can be expressed through the avatar's facial expressions (such as wide eyes and a smile) and enthusiastic signing.

Disappointment or Resignation: The second part introduces a contrast with the occurrence of rain. This might evoke feelings of disappointment or resignation, depending on the context and the perceived impact of the rain on the wedding. The avatar's expression might shift to a more neutral or slightly saddened expression to reflect this change.

### 2. Translating the Content

“The wedding was exciting”: This segment would be signed by combining signs for “wedding” and “exciting.” The sign for “exciting” would be performed with more vigor and accompanied by a positive facial expression to convey enthusiasm.

“but then it rained”: The conjunction “but” introduces a contrast, which can be signed accordingly to indicate a shift in the narrative. The phrase “it rained” would follow, with the avatar's facial expression changing to show disappointment or a slight downturn in mood. The sign for “rain” would be performed, perhaps with a slower movement or a change in facial expression to convey the unexpected or unwelcome nature of the event.

### 3. Emphasizing Contrast Through Body Language

The transition from excitement to disappointment can further be emphasized through the avatar's body language. For example, the avatar might start with an upright posture and open gestures when discussing the excitement, then shift to a slightly more subdued posture when mentioning the rain.

### 4. Graduated Sign Intensity:

When translating emotions into sign language, especially with the use of 3D avatars, acknowledging the spectrum of intensity within emotions like happiness and sadness is crucial for conveying the message accurately and realistically. Emotions aren't binary; they exist on a continuum, ranging from mild to intense.

The intensity with which signs are performed can greatly affect their emotional connotation. By adjusting the speed, size, and energy of the signs, the avatar can more accurately mirror the speaker's emotional state.

### Number Classifications:

Numbers classification in ASL encompasses a system that not only includes the basic numerical signs but also integrates specific techniques and rules for expressing quantities, ordinal numbers, ages, time, money, and other numerical concepts. This classification enhances conveying precise information in various contexts, ranging from everyday conversations to educational and professional settings. Understanding the context, including nuances of number representation in ASL is essential for accurate and effective communication.

Optionally, numbers can be combined with other signs to make compound glosses (e.g. “2 years old” in English can be shown as one sign-a combination of “age” and the number “2). Numbers may look differently depending on whether they represent years, amounts, or simply a series of digits.

Hours (amount of time): the sign for “HOUR” can be customized to numbers 1-9 by changing the handshape. If it's a number greater than 9, the sign is then separated into “[number]” followed by “HOUR”.

### Example Sentences:

“I had to sit in traffic for 2 hours”, ASL Glosses: I SIT TRAFFIC 2-HOURS
“The store is open 24 hours a day”, ASL Glosses: STORE OPEN 24 HOURS EVERY-DAY

Number classifications exist also for years.

Another example in number classifications pertains to Ordinal Numbers which are used to indicate position: first, second, third, fourth . . . and so on. In ASL, ordinal numbers 1 through 9 are done similar to cardinal numbers except they use a little twist of the wrist. Beyond “9th,” ordinal numbers start adding a “TH” after the number instead of doing the twist. An interesting difference between English and ASL is that English uses the concept of “nd” for some numbers but ASL only uses “th.” For example, English uses 22nd but ASL uses 22th.

### Example Sentences:

“I came in first place in the race”, ASL Glosses: I RACE WIN 1-ORDINAL
Another example in number classifications pertains to an amount of money. For example, an amount of money with the currency of Dollars, it is often signed as the number followed by the sign for DOLLAR. However, there are several exceptions. For 1-9, and sometimes 10, there is a separate sign. For the amount of money in cents, the sign is a combination of CENT and the number of its value. In the US, there are 4 coins that represent a certain amount of cents. Another determination is made if the price is a combination of dollars and cents, there is no need to sign “CENT”.

### Example Sentences:

“The total cost is $25.”, ASL Glosses: TOTAL COST 25 DOLLAR
“He paid $100 for the ticket.”, ASL Glosses: HE PAY 1-HUNDRED DOLLAR FOR TICKET

Other examples of influencing the gloss sequence pertain phone numbers and addresses.

It is to be noted that the listed techniques are for illustration only, and a person versed in the art would realize that other techniques for understanding contextual data of a text input and generating a gloss sequence based on the contextual data can be used for this purpose.

In some examples, the input, along with the contextual data, is processed to generate a gloss sequence that is accurate and faithful to the original meaning of the sentence, while using one or more of the above techniques. Yet, in some examples, the inputs along with the contextual data, is processed to generate an initial gloss sequence comprising one or more initial glosses based on the input. For example, in an initial stage, a corresponding gloss is retrieved for each word in the input (or the pre-processed input), based on the words' literal meaning, while ignoring, at this initial stage, any contextual data associated with the input. Then, the input and the contextual data are processed, in the manner described above, to obtain a more accurate gloss sequence, and to modify the gloss sequence with accurate glosses and classifiers, so as to obtain a modified gloss sequence. For example, one or more of the glosses in the gloss sequence can be replaced with a different, more accurate gloss, which is faithful to the original meaning of the sentence based on the processing.

In some examples, in the absence of a corresponding gloss to a word having a particular meaning in a sentence, a new gloss can be generated by gloss generation module 261, e.g., based on the English word or phrase or the initial gloss. In other cases, the new gloss can be generated irrespective of the existence of an initial gloss, for example, in cases of generating a new gloss of a sequence of letters representing a name. The gloss can represent finger spelling of a word. In such cases, a gloss corresponding to the word in the sentence may exist, however its meaning is different than the meaning in the input sentence, and hence the existing gloss is not used (as in the above example of ‘Queen’ in “Queen is my favorite rock band”). Gloss generation module 261 can determine, based on the contextual data, that a particular finger spelling gloss that is a new gloss that should be generated, surpasses a particular gloss of the initial glosses. Based on such determination, the particular initial gloss can be replaced with the particular finger spelling gloss.

Referring back to FIG. 3, the process continues to extract visual generation guidance (block 350). At block 320, the input was processed, based at least on contextual data associated with the input, to generate a gloss sequence as described above, and in a manner that will be faithful to the accurate meaning of the sentence.

In addition, the input can also be processed, based at least on the contextual data associated with the input, to extract visual generation guidance (block 350). This can be performed, e.g., by guidance generating module 262 comprised in conversion module 260. Visual generation guidance can include one or more directives pertaining to the generation of visual signs based on notation extending to a gloss sequence. The guidance can indicate how to present the gloss sequence or modify the presentation. The guidance may include instructions to a component for visual generation on how to generate the visual faithfully. As illustrated above, to raise or lower eyebrows or tilt head forward etc. when certain glosses are presented.

While visual signs corresponding to the gloss sequence can indicate which signs to present, the guidance is indicative of additional features that are relevant to presentation of the gloss sequence. For example, the guidance can pertain to facial expressions and body language non-manual markers (NMM), Indexing, alongside handshapes and their movements which are encapsulated to be presented by the signs themselves. For example, in ASL, non-manual signals such as facial expressions and head movements may play critical roles in conveying grammatical information and affect. Eyebrows are raised not to indicate surprise but as a non-manual signal for yes/no questions. Similarly, a tilt of the head is often used in combination with specific facial expressions to introduce WH-questions (who, what, where, when, why, how), adding clarity and context to the question being asked, rather than merely suggesting a questioning attitude. This is irrespective of the gloss that exists in the gloss sequence. In some examples, glosses may have lexical NMMs that are part of the expressing a particular gloss (e.g., SAD—with a sad smile) without the context of the entire sentence or text, where the linguistics' based NMMs can change and override these, such as in the example of “ARE YOU SAD?”.

In sign language interpretation, the generation of visual guidance may be crucial for conveying each sign with accuracy and expressiveness. This guidance, derived from a detailed analysis of the input's contextual data, ensures the comprehensive communication of the input's full meaning and nuances. The process of extracting and applying visual guidance involves retrieving relevant information from the predefined database, such as Guidance 234 stored in memory 230, for lexical NMMs and body movements. Meanwhile, additional visual cues needed for grammatical transformations and higher-level abstractions are generated through the translation process and the use of dedicated algorithms. Once a gloss sequence is established, the appropriate visual guidance is retrieved or generated, ensuring that each sign is presented with the correct NMMs, emotional expressions, and spatial references. This multifaceted approach to generating visual guidance enriches the quality of sign language interpretation, making it more accurate, expressive, and reflective of the original message's intent.

Visual guidance may be originated from two sources: a predefined database and the translation process, including dedicated algorithms for detecting nuances like emotions and indexing. Lexical non NMMs and specific body movements are often directly associated with glosses in a predefined database. For example, the sign for “NOT-YET” in ASL may include NMMs like head shaking or specific mouth movements, as dictated by its entry in the database. These standard representations ensure that, even without additional context, the meaning of the sign is clear and unambiguous.

Furthermore, during the translation process, additional NMMs are generated to reflect the grammatical structure of the language. This includes adaptations to convey emphasis, structure complex sentences, and include mouthing for clarity. Such grammatical NMMs, alongside visual cues for emphasis or sentence structure, are derived as part of the translation process, assisting to ensure that the subtleties of grammatical transformations are visually represented.

Additionally, the translation process may be enhanced by dedicated algorithms designed to detect emotional or indexing meta data. These algorithms analyze the input to identify and interpret emotional tones and spatial references, adjusting the visual presentation of signs accordingly. For instance, signs expressing frustration might be accompanied by specific facial expressions and body language, dynamically generated based on the emotional analysis of the input. Similarly, indexing-indicating spatial relationships and referents within the narrative-is managed through algorithms that ensure accurate representation of these elements in the visual guidance.

In some examples, the visual generation guidance pertains to presentation of the gloss sequence. For example, the later presentation of the visual signs should include raising eyebrows or tilting of the head. The guidance can include at least two layers of guidance. Each layer can comprise guidance pertaining to a separate aspect of animation of the gloss sequence. One or more of the layers may be associated with implementation priority over another layer. For example, raising eyebrows may precede other guidance in a certain implementation, and hence may be associated with a higher priority.

Guidance can pertain to various aspects of implementation. Following are some examples of possible aspects:
Prosody—often referred to as the rhythm, intonation, and stress patterns in speech, plays a crucial role in communication. It encompasses various elements such as pitch, volume, tempo, and rhythm, all of which contribute to conveying meaning and emotion effectively. Prosody in the context of language learning or speech processing, may be important in determining how information is presented and understood. Tempo, or the speed at which something is spoken or presented, is a significant aspect of prosody. In language learning or translation tasks, understanding the appropriate tempo can greatly enhance comprehension and engagement. For instance, consider the example sentence “don't touch me!” The presence of the exclamation mark suggests a heightened emotional state or urgency. In this case, the tempo should be high to reflect the intensity of the situation. In practical terms, this means that when providing glosses or translations for such a sentence, the guidance extracted from the prosody would indicate a need for a rapid pace. Glosses or translations should be delivered quickly, with transitions between them occurring swiftly to maintain the momentum and emotional impact of the original utterance. This high tempo not only mirrors the urgency of the situation but also aids in capturing the attention of the listener and conveying the appropriate tone.
Indexing in sign language involves the use of spatial locations, hand shapes, and directional movements to refer to people, places, objects, and concepts within a conversation or narrative. This mechanism allows signers to establish, reference, and track discourse participants and elements, creating a visually organized spatial map of the conversation. Indexing is commonly used to establish and refer to conversation participants. For example, a signer might assign a specific spatial location to represent a person they are talking about, and then point to that space when referring to them later in the conversation. Similar to participant reference, objects and concepts can be spatially placed and referred to throughout a dialogue. This spatial organization helps clarify the relationships between different elements within the narrative.
Directional accuracy assists in sign language interpretation, particularly helps in conveying the grammatical and semantic relationships inherent in sign languages. This aspect of visual guidance ensures that the signs which inherently involve movement are executed with precision, such that their directionality accurately reflects the intended meaning, relationships, and interactions between the entities involved. For example, for verbal agreement, many sign languages use directional verbs to indicate the subject and object within a sentence, effectively integrating verb agreement into the spatial grammar of the language. For instance, the sign for “give” might move from the signer to the person being referred to, indicating the action's direction from giver to receiver.
Contextual Non-Manual Markers (NMM): As the sign language heavily relies on facial expressions, body language, and other non-manual features alongside handshapes and movements, the guidance can indicate the required NMM when presenting the visual signs such as in cases where the type of sentence requires a visual indication, the presentation may include visual elements. For example, if the sentence describes a question, a visual indication is required in the form of lowering or raising eyebrows (depending on the type of question: open question or yes/no question).
Avatar humanization: The presentation includes, for example, cyclical animation of breathing and blinking at a constant rate. Expanding on the concept of avatar humanization involves incorporating subtle, lifelike behaviors and animations that mimic natural human actions, enhancing the avatar's realism and relatability. Humanizing avatars goes beyond mere appearance, delving into the finer details that convey the essence of human presence. Eye movements, such as looking around, following objects, or making eye contact with the user, contribute significantly to the avatar's humanization. These movements can convey attention, curiosity, and engagement.
Emotions: Incorporating emotions into language learning or speech processing systems can significantly enhance the user experience and comprehension. Emotions convey subtle nuances in communication that go beyond words alone, including facial expressions, body language, and intonation. By integrating synthetic facial expression and body language animation into these systems, developers can create more immersive and engaging experiences for users. For example, where the input text indicates frustration, such as “I can't believe this is happening!” In this case, the system would detect the emotional context and adjust its guidance accordingly. Similar to the example involving high tempo, the presence of frustration would prompt the system to suggest rapid transitions between glosses or translations. Additionally, the system could dynamically generate facial expressions and body language animations that reflect the speaker's emotional state, further reinforcing the conveyed message.

In some examples, at least one of the layers of the guidance pertains to an aspect from the above aspects.

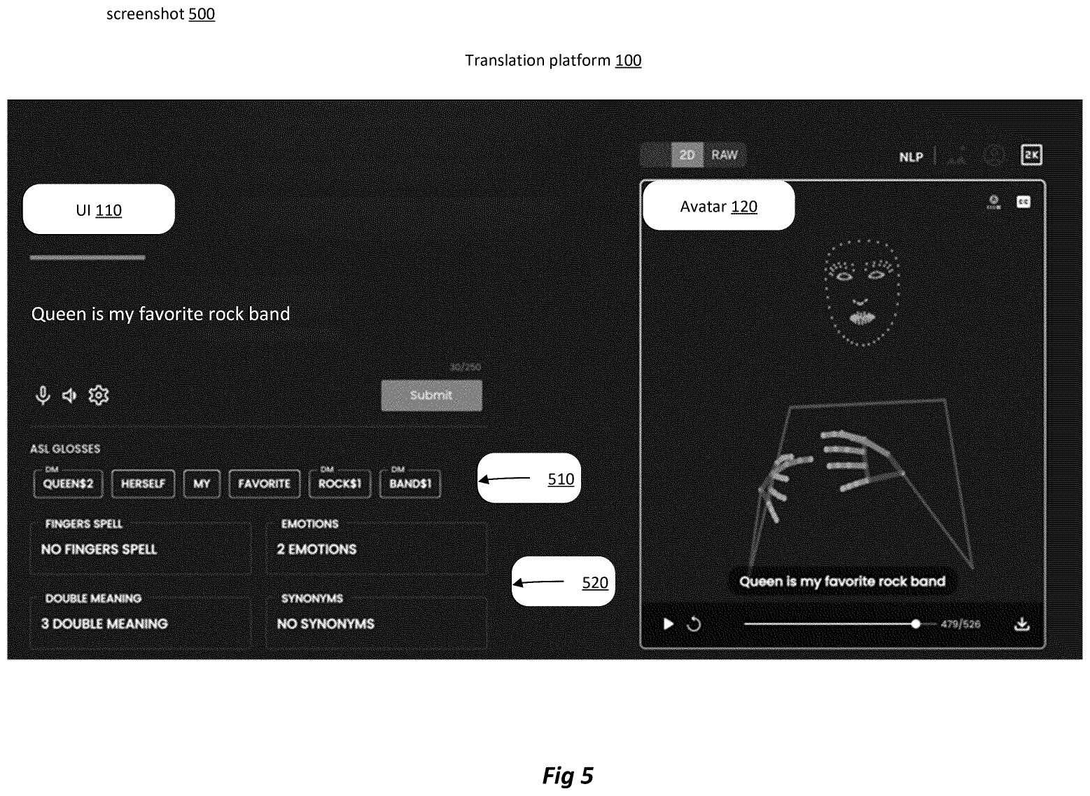

Reference is made to FIG. 5 illustrating an optional screenshot 500 of the translation platform 100, in accordance with certain embodiments of the presently disclosed subject matter. For the input of “Queen is my favorite rock band” illustrated in FIG. 5, element 510 illustrates a gloss sequence that was generated for the input, while element 520 illustrates some guidance that was extracted. The guidance includes for example, “2 Emotions”, that were identified in the input. Incidentally, the visual presentation in FIG. 5 includes a 2D presentation, however including a 3D presentation is likewise feasible. In some examples, the content of elements 510 and 520 are not displayed to the user.

In some cases, after processing the input and generating a gloss sequence, visual data corresponding to the sequence is obtained, e.g., through the visual data acquisition module 263 (block 360). This visual data may be sourced from advanced technological methods both in motion capture and computer vision, capturing the nuanced movements required for sign language interpretation. The data encompasses a visual representation that aligns with specific glosses, and may include detailed metadata such as handshape analysis, which identifies specific hand configurations, and positioning such as orientation and location to monitor the dynamics of hand and arm movements and are essential for conveying the correct sign, including direction, speed, and movement patterns. Additionally, the visual data includes interaction recognition to pinpoint hand positioning in relation to the body, as well as analyses of facial expressions and body language, further enriching the interpretation of each gloss with emotional and contextual nuances.

Known methods for collecting visual data include:

Motion Capture (MoCap): Utilizes markers or sensors attached to the signer to record movements, which are then digitally translated to animate models or characters.

Manual Animation Generation: Involves creating animations frame-by-frame using software like Maya or Blender, requiring detailed manipulation of keyframes and animation tools by skilled animators.

Computer Vision Algorithms: These are applied in both single-camera (Mono-Cam) and multi-camera (Multi-Cam) setups. Mono-Cam processes data from a video captured at a single angle, while Multi-Cam integrates data from videos captured from multiple angles simultaneously, using pose estimation algorithms to generate 3D landmark models.

The visual data extracted through these methods may be stored (e.g., in Visual Data 232 within Memory 230) and made available for reference. This storage facilitates the retrieval of precise visual presentations for each gloss, ensuring the sign language interpretation is both accurate and expressive. The Mono-Cam and Multi-Cam approaches leverage computer vision to process and analyze visual data, enhancing the detail and depth of the captured movements. Meanwhile, MoCap records and digitizes bodily movements directly, offering a dynamic and immersive dataset. Manual animation generation, though labor-intensive, provides a high degree of control over the animated sequences, allowing for nuanced portrayal of signs.

Visual data 232 may store visual data pertaining to a plurality of glosses. For example, Visual data 232 may store visual data pertaining to the gloss “HE” and visual data pertaining to the gloss “LEFT”. In some examples, Visual data 232 may store visual data that is indicative of a plurality of optional visual presentations corresponding to a particular gloss. For example, Visual data 232 may store visual data that is based on more than one technique, as described above. As such, for a particular gloss having a particular meaning, Visual data 232 may store visual data extracted from videos captured in a plurality of technologies. The stored visual data pertains to a plurality of optional visual presentations for the particular gloss. For example, with reference to FIG. 4, the gloss “LEFT$3” means the word ‘left’, when interpreted as “past tense form of allowing to remain”. According to the presently disclosed subject matter, Visual data 232 may store visual data that pertains to an optional presentation corresponding to “LEFT$3” based on the Mono-Cam CV technique, and additional visual data that pertains to an optional presentation corresponding to “LEFT$3” based on the Multi-Cam CV technique. The visual data based on both presentations is stored and available for use. This is irrespective of storing visual data pertaining to one or more presentations corresponding to the gloss of “LEFT” or “LEFT_SIDE”, all, including “LEFT$3”, referring to the word “left” in the spoken language. In some examples, for a particular gloss having several optional presentations, one of the presentations may be superior to another presentation, in terms of accuracy of the resulting visual sign, based on that presentation. For example, for signs involving importance of the distance of the hands from the body, it may be advisable to use visual data obtained based on a computer vision technique that reveals the depth dimension. Another example of superiority of one presentation over another may involve factors pertaining to the contextual data associated with the input. For example, one presentation may be superior over another, should the audience of the sign language be comprised of toddlers, while a different presentation may be superior over another in other cases. The most accurate visual data may be pre-defined, e.g. by manually tagging and ranking each sign that can come from different inputs/techniques.

Hence, it may be advisable to select an optimal visual sign presentation for a particular gloss from among a plurality of visual presentations available for that gloss. Visual data 232 may store, for some or all of the stored glosses, data indicative of the optimal presentation for each of the glosses of the available optional presentations.

Hence, in some examples, visual data acquisition module 263 can obtain visual data corresponding to the gloss sequence, for example, by obtaining data on an optional visual presentation for each gloss in the gloss sequence For at least one gloss in the gloss sequence, data of an optimal presentation will be obtained. In order to obtain the visual signs, visual data acquisition module 263 may retrieve stored visual data from a dedicated database, such as from Visual data 232. In some cases where Visual data 232 stores data on more than one presentation for a particular first gloss, then visual data acquisition module 263 can obtain data of an optimal presentation from among a plurality of visual presentations available for that particular first gloss. The selection can be made based on stored data for each presentation such as ranking of a presentation of a gloss.

Once visual data is obtained, representation module 264 can generate a visual presentation based on the gloss sequence, the visual data and the visual generation guidance (block 370). The representation can be a composited package of data including the gloss sequence, visual data on how to present the gloss sequence, and the guidance pertaining to how to present the glosses.

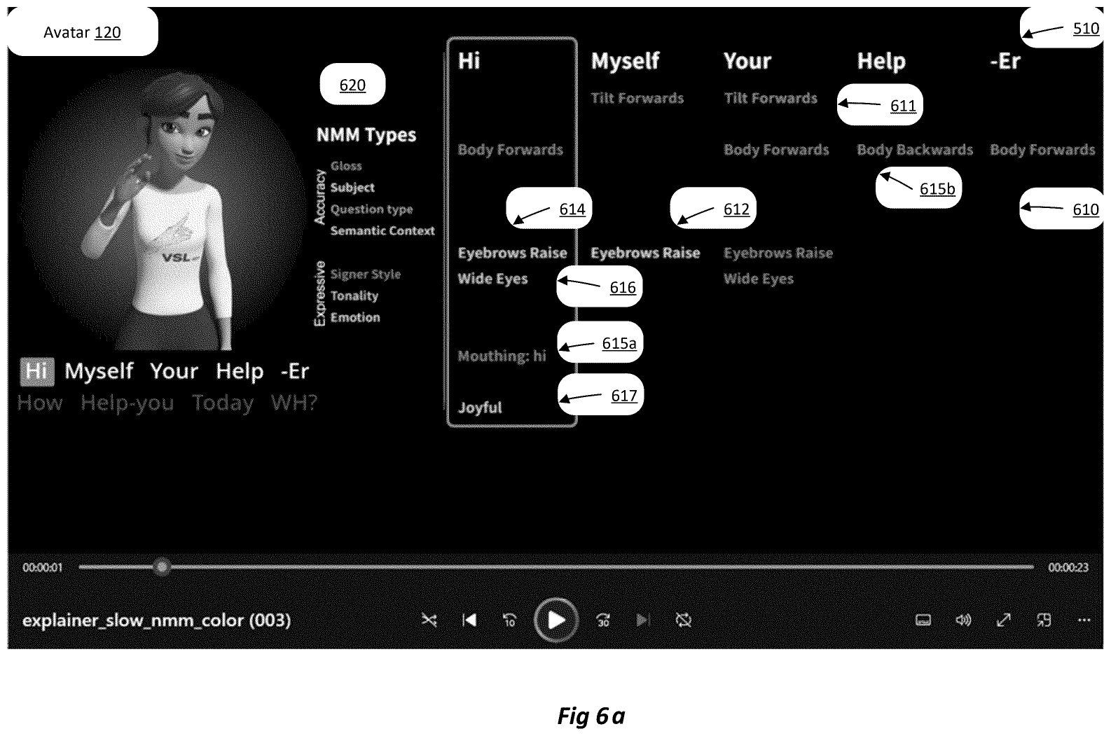

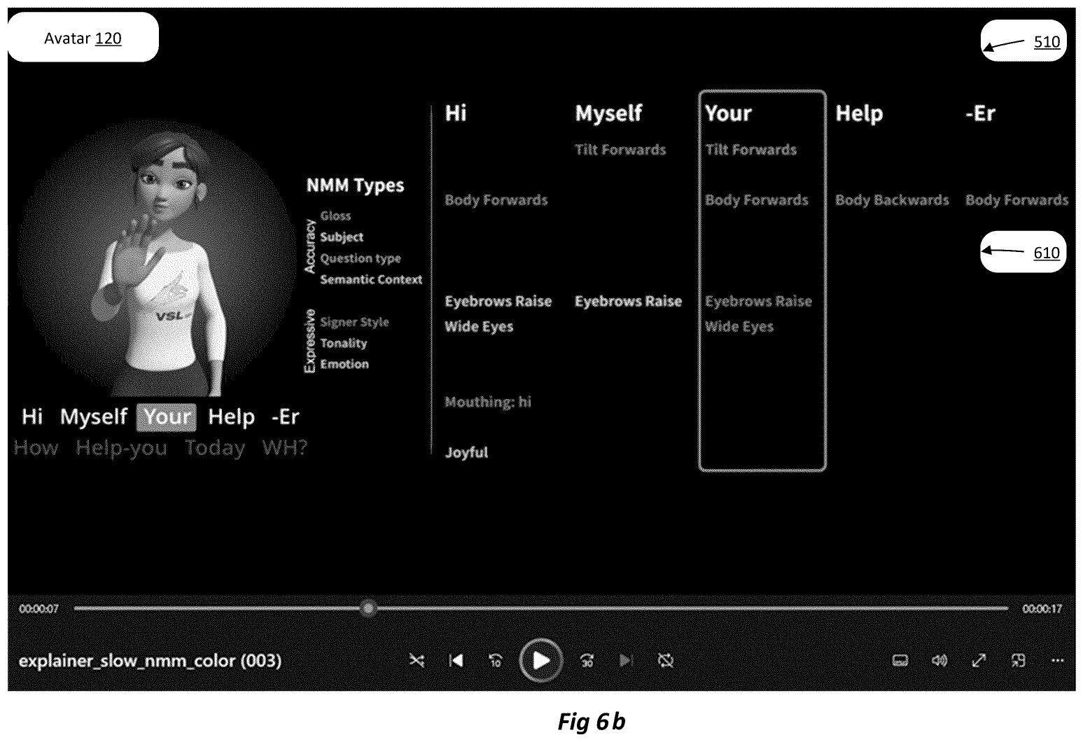

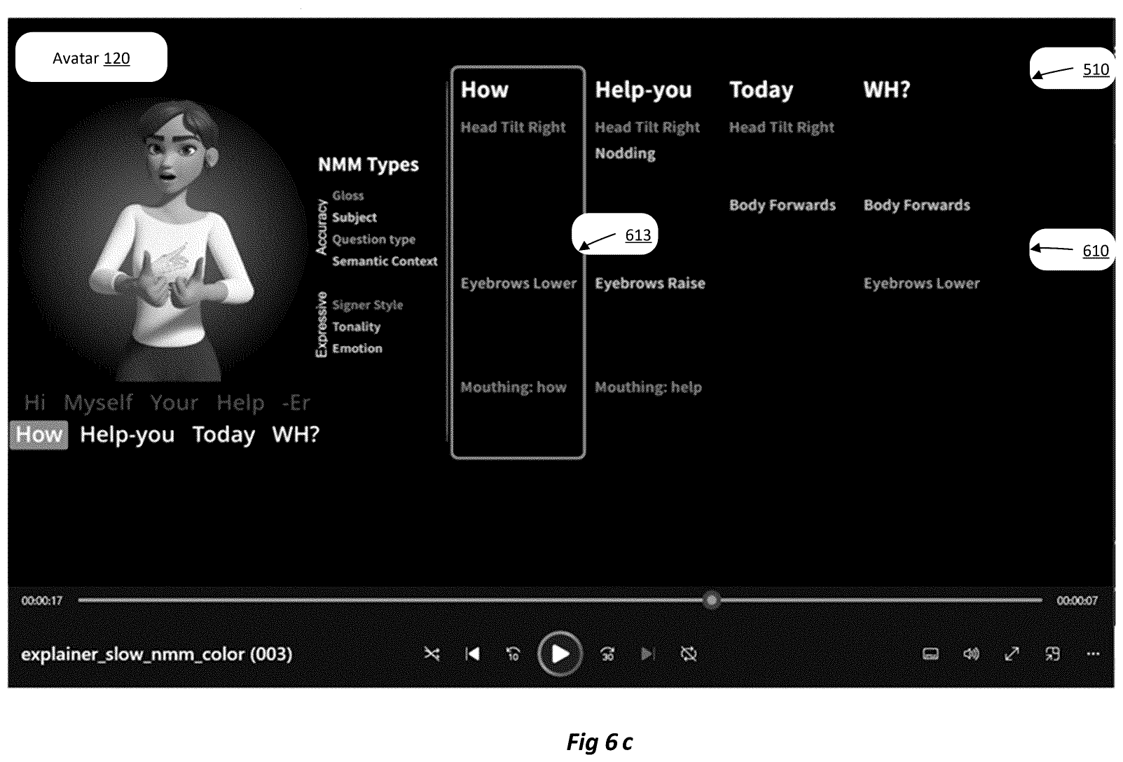

Reference is made to FIGS. 6a, 6b and 6c illustrating a non-limiting example of representation, in accordance with certain embodiments of the presently disclosed subject matter. FIGS. 6a, 6b and 6c pertains the following English sentence input: “Hi, how may I help you today?”. As shown, element 510 illustrates the gloss sequence generated for the input, while element 610 illustrates visual generation guidance associated with each of the glosses in the gloss sequence. The guidance can pertain various aspects, including NMM guidance, relating to e.g., accuracy or expressive aspects, as referenced by element 620. The NMM can include guidance for movement of different part of the body and facial expressions for each ‘gloss’ such as ‘tilt forwards’ (611 in FIG. 6a), for yes/no or rhetorical question or a subject (topicalization) such as ‘eyebrows raise’ (612 in FIG. 6a), WH question such as ‘eyebrows lower’ (613 in FIG. 6c), signer style such as ‘mouthing: hi’ and ‘body forward’ (615a and 615b in FIG. 6a), tonality such as ‘wide eyes’ (616 in FIG. 6a) and an emotion such as ‘joyful’ (617 in FIG. 6a). It should be noted that the representation illustrated in FIGS. 6a, 6b and 6c should not be considered as limiting. According to certain embodiments of the presently disclosed subject matter, other representations can be structured in a different format such that cannot be displayed as in FIGS. 6a-6c, that include the required data pertaining to a gloss sequence, the corresponding visual data and extracted guidance.

As illustrated, the gloss sequence which was generated using context data is enriched with guidance to enhance the accuracy presentation of the signs in the sign language.

Using a composited package of data as a source for the visual presentation of a particular sentence is advantageous as the representation reflects not only the selection of accurate glosses based on the context data associated with the input sentence, but also data on how to present the glosses.

Referring back to FIG. 3, the providing module 270 can then provide the representation (block 380). For example, the providing module 270 can provide the representation to an avatar module 280 that can configure a visual character such as an avatar based on the representation (block 390). The configuration can include instructions on how to implement the avatar, based on the representation. For example, the confirmation can include generating the avatar to perform a gloss sequence, where, for example, for each gloss in the gloss sequence, the avatar is configured to present handshapes based on the visual data included in the representation. The facial expressions and body of the avatar is further configured according to the guidance. With reference to FIG. 6a, the avatar is configured to present the first gloss of the gloss of “hi”. Therefore, the avatar is configured to perform handshape based on visual data of the gloss “Hi” (a motion comprised of sequence of movements including extending the avatar's finger and cross its thumb in front of its palm. Then take the avatar's hand, starting with its hand in front of its ear, and extend it outward and away from its body). Simultaneously to performing the motion, the eyebrows of the avatar are raised, the eyes are wide, the mouthing of the avatar displays the word ‘hi’, the body of the avatar is leaning forward, all when the avatar expresses joy. In some examples, the avatar can first be configured based on a user's basic confirmation such as based on selection of gender of the avatar, character or other standard preferences that users can select.

In some examples, configuration can be performed by known methods, such as retargeting process used in computer animation to adapt motion capture data from one model (such as a human actor or other manually created avatar by an animator) to another (like a 3D avatar), ensuring that the movements and expressions are accurately represented on the new model. This technique allows for the realistic and nuanced animation of digital characters, preserving the original performance's emotional and physical characteristics. Retargeting can also be applied to data from 3D pose estimation coordinates. This process involves taking the skeletal data obtained through 3D pose estimation techniques, which capture the positions and movements of a subject's joints in space and adapting this data to animate a different 3D model or avatar. It allows for the accurate transfer of human movements to digital characters, even when the source data is derived from computer vision algorithms rather than traditional motion capture systems.

In the process of creating smooth animation transitions after visual data acquisition, various algorithms and methods are employed to ensure fluidity and realism. Techniques such as Linear Interpolation (Lerp) for straightforward frame-to-frame transitions, Spherical Linear Interpolation (Slerp) for rotations and Quaternion-based movements, and Cubic Spline Interpolation for smoother, more natural curves are commonly used. Additionally, Inverse Kinematics (IK) solves for joint angles to achieve desired end effector positions, ensuring anatomically plausible movements, while Morph Target Animation blends between different mesh states to capture facial expressions and subtle gestures. These methods, combined with Motion Blending algorithms that allow for seamless transitions between different animation clips, are crucial in transforming raw 3D pose estimation data and motion capture information into lifelike animations that accurately reflect the original performance's emotional and physical characteristics.

The avatar module 280 can then render the avatar (block 392) e.g., by displaying a video of the avatar 120 performing the representation, Optionally, avatar module 280 can then render the avatar by providing video formats of the avatar performing an input, such as providing MP4 Format or 3D Formats (.glb, .gltf, bvh, fbx) suitable for various usages such as display in web and virtual environments and AR/VR Implementations. In some examples, translating the input to the sign language is performed in real time. It is noted that, as is well known in the art, systems operating in real time may experience some delay between the onset of a command and its execution, due to various reasons such as processing time and/or network communication delay. The term real-time as used herein is meant to include near real-time i.e., operation in systems that may experience some internal delays.

It is noted that the teachings of the presently disclosed subject matter are not bound by the flow chart illustrated in FIG. 3, and that the illustrated operations can occur out of the illustrated order. For example, operations <340> and <350> or <350> and <360> shown in succession can be executed substantially concurrently, or in the reverse order.

In various examples of the presently disclosed subject matter, fewer, more, and/or different stages than those shown in FIG. 3 may be executed. In embodiments of the presently disclosed subject matter, one or more stages illustrated in the figures may be executed in a different order, and/or one or more groups of stages may be executed simultaneously.

For purpose of illustration only, the following description is provided for a designated sign language being the American Sign Language (ASL). Those skilled in the art will readily appreciate that the teachings of the presently disclosed subject matter are, likewise, applicable to other sign languages.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized method for translating input to sign language, the method comprising:
obtaining an input;
converting the input to representation in a designated sign language, by:
processing the input, based at least on contextual data associated with the input, to:
generate a gloss sequence comprising one or more glosses; and
extract visual generation guidance;
obtaining visual data corresponding to the gloss sequence; and
generating representation based on the gloss sequence, the visual data and the visual generation guidance; and
providing the representation.

2. The method of claim 1, further comprising:
configuring an avatar to perform the representation;
rendering the avatar.

3. The method of claim 1, wherein obtaining an input comprises receiving the input through an API platform.

4. The method of claim 1, wherein translating the input to the sign language is performed in real time.

5. The method of claim 1, wherein processing the input further comprises:
extracting contextual data from the input; and
processing the input based at least on the extracted contextual data.

6. The method of claim 1, wherein converting the input further comprises:
prior to processing the input, restructuring or reducing the form of the input.

7. The method of claim 1, wherein processing the input to generate the gloss sequence further comprises:
generating an initial gloss sequence comprising one or more initial glosses based on the input; and
modifying the generated initial gloss sequence based on the contextual data, to generate a modified gloss sequence.

8. The method of claim 7, wherein modifying the generated initial gloss sequence further comprises:
replacing at least one of the initial glosses with a different gloss.

9. The method of claim 8, wherein replacing at least one of the initial glosses further comprises:
for at least one of the initial glosses, generating a new gloss based on the initial gloss; and
replacing one of the initial glosses with the new gloss.

10. The method of claim 9, wherein the new gloss represents finger spelling of a word.

11. The method of claim 10, further comprising:
determining, based on the contextual data, that a particular finger spelling gloss surpasses a particular one of the initial glosses; and
replacing the particular initial gloss with the particular finger spelling gloss.

12. The method of claim 1, wherein processing the input to generate a gloss sequence comprises applying on the input at least one technique selected from a group comprising: N-grams to gloss, synonyms, finger spelling, homograph disambiguation, Temporal Aspect Modifiers, and number classifications.

13. The method of claim 1, wherein processing the input to generate a gloss sequence comprises applying a classifiers matching technique.

14. The method of claim 1, wherein processing the input to generate a gloss sequence comprises applying an emotional technique.

15. The method of claim 1, wherein obtaining the visual data further comprises:
for at least a first gloss in the gloss sequence, obtaining visual data of an optimal presentation from among a plurality of visual presentations available for the first gloss.

16. The method of claim 15, wherein the plurality of visual presentations is generated using one or more techniques selected from a group comprising: Mono-Cam computer vision (CV), Multi-Cam CV, Motion Capture (MoCap) and manual generation.

17. The method of claim 1, wherein the visual generation guidance pertains to presentation of the gloss sequence.

18. The method of claim 16, wherein the visual generation guidance includes at least two layers of guidance, wherein each layer comprises guidance pertaining to a separate aspect of animation of the gloss sequence.

19. The method of claim 18, wherein at least one of the layers is associated with implementation priority over another layer.

20. The method of claim 18, wherein at least one of the layers pertains to one aspect selected from a group comprising: transitions between at least two of the glosses, emotions, animated Indexing, grammatical structure, Contextual Non-Manual Markers (NMM), classifiers, and avatar humanization.

21. A computerized system for translating input to sign language, the system comprising a processing circuitry comprising at least one processer and computer memory, the processing circuitry being configured to execute a method as defined by claim 1.

22. A non-transitory computer readable storage medium tangibly embodying a program of instructions that, when executed by a computer, cause the computer to perform a method for translating input to sign language as defined by claim 1.

23. A personal assistant system, comprising:
a reception unit for receiving an input from a user;
one or more processors configured to:
process the input using language learning models (LLMs) to generate processed data;
translate the processed data to sign language utilizing the method of claim 1 to generate the representation; and
an output interface for providing the representation.

24. A personal assistant system, comprising:
a reception unit configured to receive an input from an external system, the reception unit comprising one or more processors configured to process the input using language learning models (LLMs) to generate processed data; and
one or more processors configured to translate the processed data to sign language utilizing the method of claim 1 to generate the representation; and
an output interface for providing the representation.
